(19) United States
(12) Patent Application Publication
(10) Pub. No.: US 2025/0301083 A1
(43) Pub. Date: Sep. 25, 2025

(54) IMAGE FORMING APPARATUS, INFORMATION PROCESSING METHOD, AND NON-TRANSITORY RECORDING MEDIUM

(71) Applicant: Yoshiki HAMASAKI, Kanagawa (JP)

(72) Inventor: Yoshiki HAMASAKI, Kanagawa (JP)

(21) Appl. No.: 19/080,952

(22) Filed: Mar. 17, 2025

(30) Foreign Application Priority Data
Mar. 22, 2024 (JP) 2024-045905
Dec. 3, 2024 (JP) 2024-210023

(51) Int. Cl. H04N 1/00; B41J 2/165; B41J 2/21; B41J 3/46; G06K 15/00

(52) U.S. Cl. CPC H04N 1/00909; B41J 2/16579; B41J 2/2142; B41J 3/46; G06K 15/408; H04N 1/00037; H04N 1/00074; H04N 1/0009; G06K 2215/101; H04N 2201/0081

(57) ABSTRACT

An image forming apparatus includes a reading device to read an image, a control unit to detect a first spot from the image read by the reading device, a storage to store first spot information of the first spot detected from the image and date-and-time information of time of detection of the first spot, and a display to display a clean message to clean the reading device. The control unit further detects second spot information from the image stored in the storage, compares the first spot information and the second spot information to determine whether the reading device is to be cleaned based on the first spot information, the date-and-time information and the second spot information, and causes the display to display the clean message when the reading device is determined to be cleaned.

### CROSS-REFERENCE TO RELATED APPLICATIONS

This patent application is based on and claims priority pursuant to 35 U.S.C. § 119(a) to Japanese Patent Application No. 2024-045905, filed on Mar. 22, 2024, in the Japan Patent Office, and Japanese Patent Application No. 2024-210023, filed on Dec. 3, 2024, in the Japan Patent Office, the entire disclosure of which are hereby incorporated by reference herein.

### BACKGROUND

### Technical Field

The present disclosure relates to an image forming apparatus, an information processing method, and a non-transitory recording medium.

### Related Art

In terms of the density of an image output from an image forming apparatus, some techniques are known that read an image formed by discharging ink from multiple discharge heads with a scanner and control the ink amount discharged from multiple discharge heads to uniformize the density of a printed image based on the reading result of the formed image. In the correction process that uniformizes the density, when the printed matter printed by the discharge heads is read by a scanner and the scanner has a spot, the correction accuracy is lowered. Thus, in order to perform the density uniformizing process, the spot of the scanner is appropriately detected. Accordingly, when the spot of the scanner is removed based on the detection result, the density uniformizing process can be performed with high accuracy.

Some techniques have been proposed that display a message for prompting the cleaning of a reading unit when the value determined by the size of a detected factor (e.g., spot, dust, stain, or smudge) that causes an abnormal pixel is greater than a threshold.

### SUMMARY

According to an embodiment of the present disclosure, an image forming apparatus includes a reading device to read an image, a control unit to detect a first spot from the image read by the reading device, a storage to store first spot information of the first spot detected from the image and date-and-time information of time of detection of the first spot, and a display to display a clean message to clean the reading device. The control unit further detects second spot information from the image stored in the storage, compares the first spot information and the second spot information to determine whether the reading device is to be cleaned based on the first spot information, the date-and-time information and the second spot information, and causes the display to display the clean message when the reading device is determined to be cleaned.

According to an embodiment of the present disclosure, a an image forming apparatus includes a reading device to read an image, a control unit to detect a first spot from the image read by the reading device, a storage to store first spot information of the first spot detected from the image, and first date-and-time information of time of detection of the first spot, and a cleaner to clean the reading device. The control unit detects second spot information from the image stored in the storage, compares the first spot information and the second spot information to determine whether the reading device is to be cleaned based on the first spot information, the date-and-time information, and the second information, and causes the cleaner to clean the reading device.

According to an embodiment of the present disclosure, an information processing method includes reading an image by a reading device, detecting a first spot from the image read by the reading device, storing first spot information of the first spot and date-and-time information of time of detection of the first spot in a storage, detecting second spot information from the image stored in the storage, comparing the first spot information and the second spot information, determining whether the reading device is to be cleaned based on the first spot information, the date-and-time information, and the second spot information, and displaying a clean message when the reading device is determined to be cleaned.

A non-transitory recording medium storing multiple instructions which, when executed by one or more processors, causes the one or more processors to perform a method, includes reading an image by a reading device; detecting a first spot from the image read by the reading device, storing first spot information of the first spot and date-and-time information of time of detection of the first spot in the storage, detecting second spot information from the image stored in the storage, comparing the first spot information and the second spot information; determining whether the reading device is to be cleaned based on the first spot information, the date-and-time information, and the second spot information, and displaying a clean message when the reading device is determined to be cleaned.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of a system including an image forming apparatus according to a first embodiment;

FIG. 2 is a schematic diagram illustrating a configuration of an image forming apparatus;

FIG. 3 is a schematic diagram illustrating a configuration of an image forming apparatus including a discharge head of a line-head liquid discharge unit and a reading device;

FIG. 4 is a diagram illustrating a hardware configuration of an image forming apparatus;

FIG. 5 is a diagram illustrating a hardware configuration of a digital front end;

FIG. 6 is a diagram illustrating a configuration of functional blocks of an image forming apparatus and a digital front end according to the first embodiment;

FIG. 7 is a diagram illustrating a chart used for performing a uniformizing process;

FIG. 8 is a diagram illustrating read data of a chart read by a reading device;

FIGS. 9A and 9B are diagrams illustrating a uniformizing process;

FIG. 10 is a flowchart of a process of determining whether cleaning of a reading device is required;

FIG. 11 is a diagram illustrating a configuration of functional blocks of an image forming apparatus and a digital front end according to a modification of the first embodiment;

FIG. 12 is a diagram illustrating reading data before and after cleaning of a reading device;

FIG. 13 is a diagram illustrating a configuration of functional blocks of an image forming apparatus and a digital front end according to a second embodiment; and

FIG. 14 is a flowchart of a process of determining whether cleaning of a nozzle is required.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to embodiments of the present disclosure, the usability of the user can be increased.

In the following description, an image forming apparatus, an image processing method, and a non-transitory recording medium will be described in detail with reference to the drawings. The present disclosure is not limited to the following embodiments, and the constituent elements of the embodiments includes those which can be easily conceived by those skilled in the art, substantially the same ones, and those in the following embodiments include those which can be easily conceived by those skilled in the art, substantially the same, and within equivalent ranges. Further, various omissions, substitutions, changes and combinations of constituent elements can be made without departing from the gist of the following embodiments.

The computer software is a program relating to the operation of a computer, or other information provided for use in processing by a computer, which is a quasi-program. In the following description, the computer software may be referred to as software. Application software is a generic term for software used to perform a specific task in a software classification. On the other hand, an operating system (OS) is software that controls a computer and allows computer resources to use for application software. The operating system performs basic management and control of the computer, such as control of input and output, management of hardware such as a memory and a hard disk, and management of processing. Application software operates by utilizing the functions supplied by the operating system. A program is a set of instructions to a computer that are combined to produce a result. In addition, a quasi-program is not referred to as a program because it is not a direct instruction to a computer, but has a property similar to a program in that it specifies processing of a computer. For example, the quasi-program includes a data structure (that is a logical structure of data represented by interrelationships between data elements).

### First Embodiment

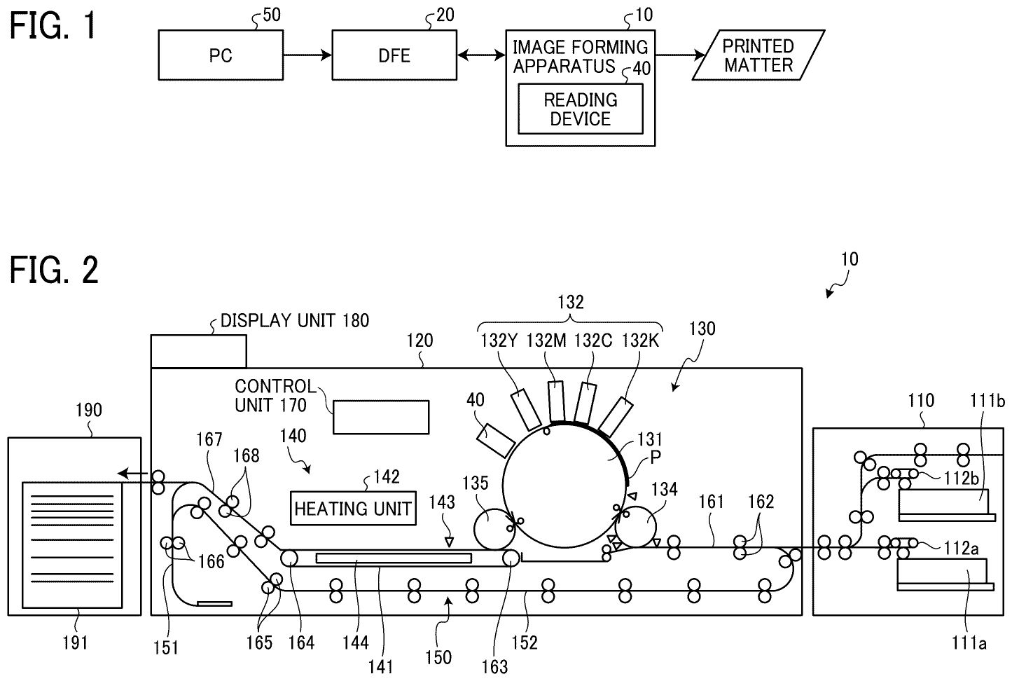

FIG. 1 is a schematic diagram illustrating a configuration of a system including an image forming apparatus 10. The system illustrated in FIG. 1 is a system that receives a job subject to printing from a personal computer (PC) 50 and outputs the print. The system includes the image forming apparatus 10 and a digital font end (DFE) 20.

The image forming apparatus 10 is an image forming apparatus that forms an image on a medium such as a fed sheet by a liquid discharge method such as an inkjet method and ejects the sheet. As illustrated in FIG. 1, the image forming apparatus 10 includes a reading device 40. The reading device 40 is a device that performs a reading process on an image formed on a sheet. The reading device 40 is described as a device disposed in the image forming apparatus 10, but not limited to, and may be a separate device that is not disposed in the image forming apparatus 10.

The DFE 20 is an information processing device that outputs print data to the image forming apparatus 10 based on a print job received from the PC 50 and causes the image forming apparatus 10 to perform image formation.

The image forming apparatus 10 has an image processing function described later, and can perform image processing such as a uniformizing process that uniformizes the density of an image formed by the liquid discharge unit of the image forming apparatus 10, using read data read by the reading device 40. The image forming apparatus 10 has a function that stores spot information, a function that determines whether cleaning is required, and a function of information processing including an image processing function, which will be described later. Although the image processing and information processing are functions of the image forming apparatus 10, these functions may be implemented as functions included in the DFE 20 or as functions of a device different from the image forming apparatus 10 or the DFE 20.

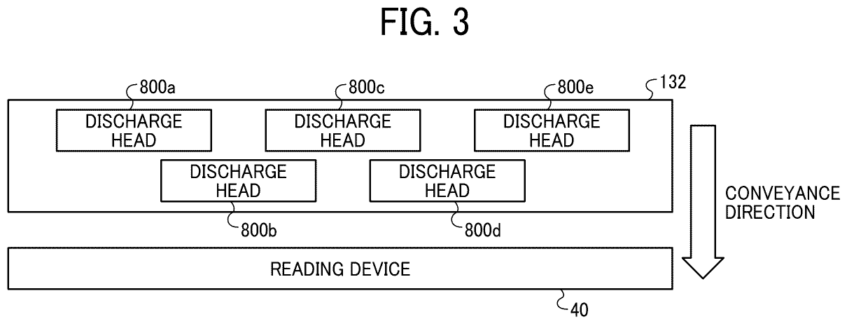

FIG. 2 is a schematic diagram illustrating a configuration of the image forming apparatus 10. FIG. 3 is a schematic diagram illustrating a configuration of the image forming apparatus 10 including discharge heads 800a to 800e of a line-head liquid discharge unit 132 and a reading device. Referring to FIGS. 2 and 3, a schematic configuration of the image forming apparatus 10 will be described.

As illustrated in FIG. 2, the image forming apparatus 10 includes a loading unit 110, a printing unit 120, and an unloading unit 190.

The loading unit 110 is a unit that loads a sheet material P as a sheet-shaped print medium. As illustrated in FIG. 2, the loading unit 110 includes a lower loading tray 111a and an upper loading tray 111b that accommodate multiple sheet materials P, a feeder 112a that separates and feeds the sheet material P one by one from the lower loading tray 111a, and a feeder 112b that separates and feeds the sheet materials P one by one from the upper loading tray 111b. The loading unit 110 supplies the sheet material P sent out from the feeders 112a and 112b to the image forming unit 130. A pretreatment unit that applies a coating liquid such as a pretreatment liquid to the sheet material P may be disposed between the loading unit 110 and the printing unit 120.

The printing unit 120 is a unit that forms an image by discharging ink onto the sheet material P supplied from the loading unit 110 by an inkjet method with a line head. As illustrated in FIG. 2, the printing unit 120 includes an image forming unit 130, a fixing unit 140, a double-sided printing unit 150, a control unit 170, and a display unit 180.

The image forming unit 130 is a unit that forms an image by causing a liquid discharge unit 132 to discharge ink onto the sheet material P supplied from the loading unit 110 and conveyed on the loading path 161 by the conveyance roller pair 162. As illustrated in FIG. 2, the image forming unit 130 includes a drum 131, a liquid discharge unit 132, an inlet rotator 134, and an outlet rotator 135.

The drum 131 is a rotational member including a gripper as gripping member, and grips the leading edge of the sheet material P sent from the inlet rotator 134 by the gripper to convey the sheet material P by a rotation operation. The drum 131 has multiple suction holes formed in a dispersed manner on the surface of the drum 131, and a suction unit sucks air through suction holes to the inside so as to stick the sheet material P on the peripheral surface of the drum 131

The liquid discharge unit 132 is a unit that discharges ink onto the sheet material P conveyed by the rotation of the drum 131 to form an image. The liquid discharge unit 132 includes a liquid discharge unit 132C that discharges cyan (C) ink, a liquid discharge unit 132M that discharges magenta (M) ink, a liquid discharge unit 132Y that discharges yellow (Y) ink, and a liquid discharge unit 132K that discharges black (K) ink. The liquid discharge units 132C, 132M, 132Y, and 132K are also referred to as the liquid discharge units 132 when any of the liquid discharge units is indicated or when they are collectively referred to. The ink is not limited to C, M, Y, and K, and may include a liquid discharge unit that discharges a special liquid such as white, gold, silver, or fluorescent.

Each liquid discharge unit 132 is controlled in a discharging operation by a drive signal corresponding to print data. When the sheet material P carried on the drum 131 passes through the peripheral surface region of the drum 131 facing the liquid discharge unit 132, the ink of each color is discharged from the liquid discharge unit 132, and an image corresponding to the print data is formed (printed). The sheet material P on which the image is formed is passed from the drum 131 to the outlet rotator 135.

The liquid discharge unit 132 is a unit of a line-head type, and as illustrated in FIG. 3, the discharge heads 800a to 800e are arranged in parallel in a main scanning direction orthogonal to a conveyance direction (i.e., sub-scanning direction). The discharge heads 800a to 800e are simply referred to as “discharge head 800” when it indicates any discharge heads or when they are collectively referred to the discharge head.

As illustrated in FIGS. 2 and 3, the reading device 40 is disposed downstream from the liquid discharge unit 132 in the direction in which the sheet material P is conveyed by the rotation of the drum 131. The reading device 40 performs a reading process with respect to the image formed on the sheet material P by the liquid discharge unit 132 and generates reading data indicating the density of the image.

The inlet rotator 134 is a rotary body that transfers the sheet material P fed from the upstream side to the receiving drum 131. The inlet rotator 134 has a gripper as a gripping member on the outer periphery of the inlet rotator 134, grips the sheet material P conveyed by the conveyance roller pair 162 on the loading path 161 with the gripper, and conveys the sheet material P to the drum 131 by the rotation operation. The sheet material P, the leading edge of which is gripped by the gripper, is conveyed with the rotation of the inlet rotator 134, and is sent to the drum 131 at a position at which the inlet rotator 134 and the drum 131 face each other.

The outlet rotator 135 is a rotary body that receives the sheet material P conveyed by the rotation of the drum 131 and sends the sheet material P to the fixing unit 140. The outlet rotator 135 has a gripper as a gripping member on the outer periphery thereof, and grips the sheet material P conveyed by the rotation of the drum 131 with the gripper, and conveys the sheet material P to the conveying belt 141 of the fixing unit 140 by the rotation operation. The outlet rotator 135 may be connected to the inlet rotator 134 via a gear and may rotate in conjunction with the inlet rotator 134.

The fixing unit 140 is a unit that dries and fixes the ink on the sheet material P on which the image is formed by the image forming unit 130. As a result, liquid components such as moisture in the ink on the sheet material P are evaporated, the colorant contained in the ink is fixed on the sheet material P, and the curl of the sheet material P is prevented. As illustrated in FIG. 2, the fixing unit 140 includes a conveying belt 141, a heating unit 142, a sheet detection sensor 143, and a suction unit 144.

The conveying belt 141 is an endless belt that conveys the sheet material P sent from the outlet rotator 135 and is stretched between the driving roller 163 and the driven roller 164. The conveying belt 141 conveys the sheet material P downstream so as to pass through the heating unit 142 at a predetermined conveying speed when performing the conveying operation of the sheet material P. The conveying speed of the sheet material P conveyed by the conveying belt 141 is set by the rotation speed of the driving roller 163. The rotation speed of the driving roller 163 is controlled by the control unit 170. When the leading edge of the sheet material P is separated from the outlet rotator 135 and is passed to the conveying belt 141, the rotation speed of the driving roller 163 is adjusted so that the conveying belt 141 operates at a predetermined conveying speed. The multiple holes are formed in a dispersed manner on the surface of the conveying belt 141, and the sheet material P is sucked and stuck on the conveying belt 141 by the suction airflow by the suction unit 144.

The heating unit 142 is a device that heats the sheet material P conveyed by the conveying belt 141. The heating unit 142 dries and fixes the ink on the sheet material P by heating the sheet material P.

The sheet detection sensor 143 is a sensor that detects the sheet material P that is sent from the outlet rotator 135 to the conveying belt 141 and conveyed to the fixing unit 140.

The suction unit 144 is a device that performs a suction operation of generating the suction airflow to suck air into the holes on the conveying belt 141 to stick the sheet material P onto the conveying belt 141.

The sheet material P that has passed through the fixing unit 140 is conveyed on an unloading path 167 by rotation of the conveyance roller pair 168 and is sent to the double-sided printing unit 150 and the unloading unit 190.

The double-sided printing unit 150 is a unit that reverses the sheet material P that has passed through the fixing unit 140 and feeds the sheet material P again to the upstream side of the image forming unit 130, that is, to the loading path 161, when printing is performed on both sides of the sheet material P. As illustrated in FIG. 2, the double-sided printing unit 150 includes a reverse path 151 and a double-sided path 152.

The reverse path 151 is a path that receives the sheet material P that has passed through the fixing unit 140 and reverses the front and back sides of the sheet material P by rotation of the conveyance roller pair 166.

The double-sided path 152 is a path that conveys the sheet material P reversed by the reverse path 151 to the upstream side of the image forming unit 130 by rotation of the conveyance roller pair 165 and feeds the sheet material P again to the loading path 161.

The control unit 170 is a controller that controls the operation of the entire image forming apparatus 10. The control unit 170 controls, for example, an image forming operation in the image forming unit 130, a drying operation in the fixing unit 140, and a conveying operation in various conveying paths. The loading unit 110 or the unloading unit 190 may be controlled by a separate control unit different from the control unit 170.

The display unit 180 is a display device that displays various information such as the operating state of the image forming apparatus 10, print setting information, and job status. The display unit 180 may include a touch panel that implements, for example, a touch input function in addition to the display function.

The unloading unit 190 is a unit that accumulates the sheet material P carried out from the printing unit 120. The unloading unit 190 includes an unloading tray 191 on which multiple sheet materials P are stacked. The sheet materials P conveyed from the printing unit 120 are stacked and held on the unloading tray 191 in order.

In the present embodiment, an example in which the line-head method is applied as the image forming apparatus 10 is described. However, the present disclosure is not limited to this. A serial type (i.e., shuttle type) inkjet recording apparatus in which a carriage scans can be applied as the image forming apparatus 10.

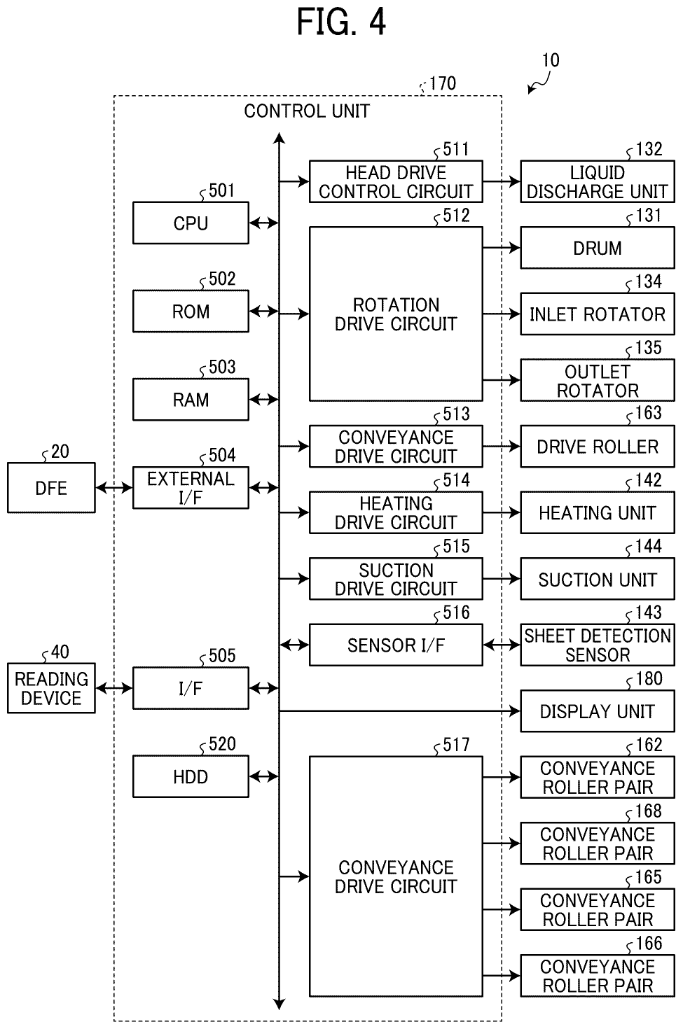

FIG. 4 is a diagram illustrating an example of a hardware configuration of the image forming apparatus 10.

As illustrated in FIG. 4, the control unit 170 includes a central processing unit (CPU) 501, a read-only memory (ROM) 502, a random-access memory (RAM) 503, an external interface (I/F) 504, and an interface (I/F) 505, a head drive control circuit 511, a rotation drive circuit 512, a conveyance drive circuit 513, a heating drive circuit 514, a suction drive circuit 515, a sensor I/F 516, a conveyance drive circuit 517, and a hard disk drive (HDD) 520, which can perform data communication with each other via a bus line.

The CPU 501 is a computing unit that reads various programs stored in the ROM 502 into the RAM 503 used as a work area to implement various functions.

The external I/F 504 is an interface for performing communication with the DFE 20 via a network such as a local area network (LAN) or a wide area network (WAN) constructed by a data transmission path such as a wired or wireless network.

The I/F 505 is an interface for performing data communication with the reading device 40. The I/F 505 receives, for example, read data read from a printed matter by the reading device 40.

The head drive control circuit 511 is a drive circuit that controls the discharge operation of the liquid discharge unit 132 of the printing unit 120 based on the print data according to the instruction of the CPU 501.

The rotation drive circuit 512 is a drive circuit that controls the rotation operation of the drum 131, the inlet rotator 134, and the outlet rotator 135 of the image forming unit 130 according to an instruction from the CPU 501. The inlet rotator 134 and the outlet rotator 135 may be connected so as to be rotated according to rotation of the drum 131. In such a case, the rotation drive circuit 512 may control the rotation operation of the drum 131.

The conveyance drive circuit 513 is a drive circuit that controls the rotation operation of the driving roller 163 of the fixing unit 140 according to an instruction from the CPU 501, and conveys the sheet material P by the conveying belt 141.

The heating drive circuit 514 is a drive circuit that controls the heating operation of the heating unit 142 of the fixing unit 140 according to an instruction from the CPU 501.

The suction drive circuit 515 is a drive circuit that controls the suction operation of the suction unit 144 of the fixing unit 140 according to an instruction from the CPU 501.

The sensor I/F 516 is an interface that receives detection information detected by various sensors such as the sheet detection sensor 143 disposed in the image forming apparatus 10.

The conveyance drive circuit 517 is a drive circuit that controls the rotation operations of the conveyance roller pair 162, the conveyance roller pair 168, the conveyance roller pair 165, and the conveyance roller pair 166 according to an instruction from the CPU 501.

The HDD 520 is a nonvolatile storage device that stores programs and data. The programs and data stored in the HDD 520 include an OS that controls the entire image forming apparatus 10 and application software that provides various functions on the OS.

The image forming apparatus 10 may use a solid state drive (SSD) instead of the HDD 520. The HDD 520 manages the stored programs and data by a predetermined file system or database.

The hardware configuration of the control unit 170 illustrated in FIG. 4 is an example, and other components may be included. For example, the control unit 170 may include, in addition to those illustrated in FIG. 4, a non-volatile RAM (NVRAM), an application specific integrated circuit (ASIC) that executes image processing, or a field-programmable gate array (FPGA) that performs input-and-output signal processing.

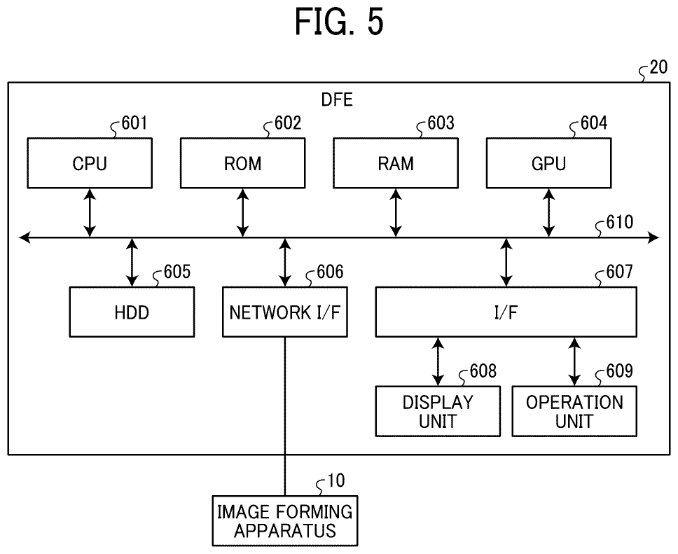

FIG. 5 is a diagram illustrating an example of a hardware configuration of the DFE 20.

As illustrated in FIG. 5, the DFE 20 includes a CPU 601, a ROM 602, a RAM 603, a graphics processing unit (GPU) 604, an HDD 605, a network I/F 606, an I/F 607, a display unit 608, and an operation unit 609. These devices are connected by a bus 610, and can perform data communication with each other.

The CPU 601 is a computing unit that reads programs and data from storage devices such as the ROM 602 and the HDD 605 onto the RAM 603 so as to execute processing to control the entire DFE 20 and implement functions of the DFE 20.

The ROM 602 is a nonvolatile storage device that can hold programs and data. The ROM 602 stores programs and data such as a basic input/output system (BIOS), an OS setting, and network settings executed when the DFE 20 is started.

The RAM 603 is a volatile storage device used as a work area of the CPU 601.

The GPU 604 is a computing device specialized in real-time image processing.

The HDD 605 is a nonvolatile storage device that stores programs and data. The programs and data stored in the HDD 605 include an OS that controls the entire DFE 20 and application software that provides various functions on the OS. The DFE 20 may use an SSD instead of the HDD 605. The HDD 605 manages the stored programs and data by a predetermined file system or database.

The network I/F 606 is an interface that connects the DFE 20 to a network. Accordingly, the DFE 20 can perform data communication with the image forming apparatus 10 via the network I/F 606.

The I/F 607 is an interface for connecting the display unit 608 and the operation unit 609 to the bus 610.

The display unit 608 is a display and is a device that displays the processing result by the DFE 20.

The operation unit 609 is, e.g., a keyboard, a mouse, or a touch panel and is a device used by a user to input operation signals.

The hardware configuration of the DFE 20 is not limited to the hardware configuration illustrated in FIG. 5. For example, at least one of the display unit 608 or the operation unit 609 may be connected to the DFE 20 when necessary.

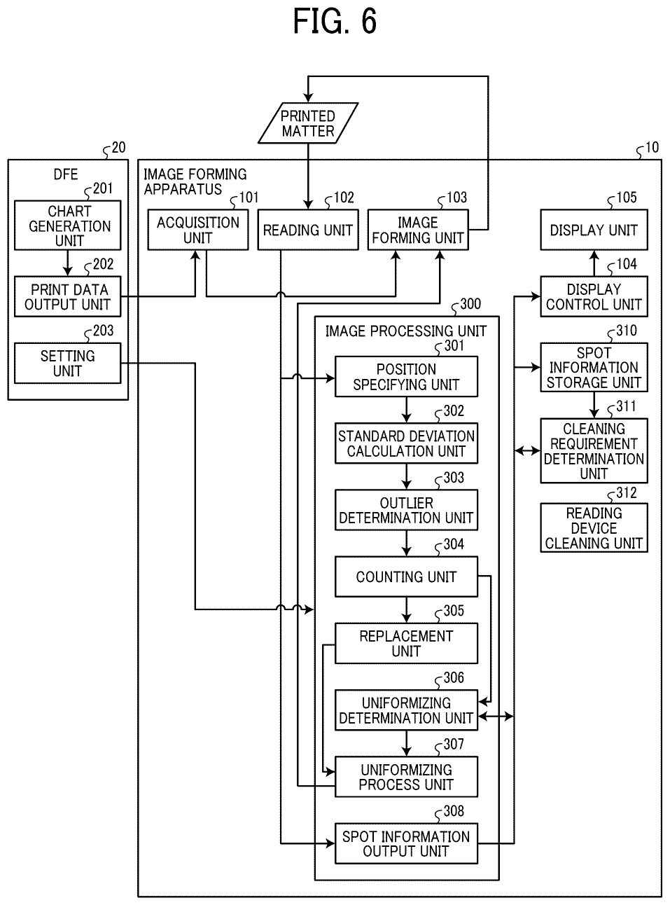

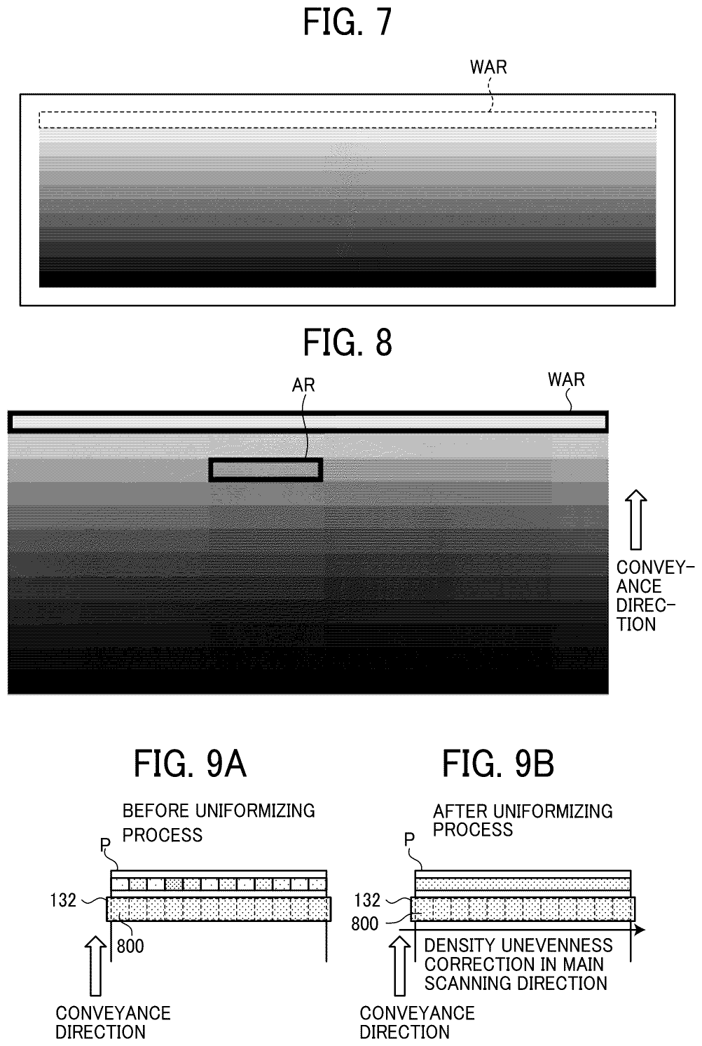

FIG. 6 is a diagram illustrating an example of the configuration of the functional blocks of the image forming apparatus 10 and the DFE 20 according to the present embodiment. FIG. 7 is a diagram illustrating a chart used for performing the uniformizing process. FIG. 8 is a diagram illustrating an example of read data of a chart read by a reading device 40. FIGS. 9A and 9B are diagrams illustrating uniformizing processing. Referring to FIGS. 6 to 9B, the configuration of the functional block and the operation of the image forming apparatus 1 according to an embodiment of the present disclosure will be described.

As illustrated in FIG. 6, the DFE 20 includes a chart generation unit 201, a print data output unit 202, and a setting unit 203.

The chart generation unit 201 is a functional unit that produces printing data of a chart used in the uniformizing process. The uniformizing process is a process for uniformly correcting the density of an image formed by the liquid discharge unit of the image forming apparatus 10 in the main scanning direction. FIG. 7 is a diagram illustrating an example of a chart used in the uniformizing process. As illustrated in FIG. 7, the chart used in the uniformizing process has a configuration in which band-shaped areas, each of which has a constant density in the main scanning direction when the chart is printed on the sheet material P, are arranged in the sub-scanning direction (i.e., the conveying direction of the sheet material P) so as to have stepwisely changed densities. In an example illustrated in FIG. 7, the chart used for the uniformizing process has a configuration in which the band-shaped areas are arranged so that the density becomes gradually higher from the upper end to the lower end in FIG. 7. However, the chart is not limited to this, and, for example, the chart may have a configuration in which the band-shaped areas are arranged so that the density becomes gradually lower from the upper end to the lower end, or may have a configuration in which the band-shaped areas of different densities are arranged at random. In an example of the chart illustrated in FIG. 8, a paper white area WAR in which ink is not printed is provided on one end (the upper end in the drawing of FIG. 7) of the band-shaped area group.

The print data output unit 202 is a functional unit that outputs print data of a chart generated by the chart generation unit 201 or print data received from an external apparatus via the network I/F 606 in order to cause the image forming apparatus 10 to perform a print process.

The setting unit 203 is a functional unit that sets parameters such as various thresholds used in the spot detection and the uniformizing process described later, in accordance with an operation input to the operation unit 609. The setting unit 203 transmits the set parameters to the image forming apparatus 10 via the network I/F 606.

The chart generation unit 201, the print data output unit 202, and the setting unit 203 are implemented by executing programs by the CPU 601 illustrated in FIG. 5. A part or all of the chart generation unit 201, the print data output unit 202, and the setting unit 203 may be implemented by an integrated circuit such as an FPGA or an ASIC, instead of a program including software.

The functional units of the DFE 20 illustrated in FIG. 6 conceptually illustrates the functions, and the present disclosure is not limited to such a configuration. For example, multiple functional units illustrated as independent functional units in the DFE 20 illustrated in FIG. 6 may be configured as one functional unit. On the other hand, the functions included in one functional unit in the DFE 20 illustrated in FIG. 7 may be divided into multiple functional units.

As illustrated in FIG. 6, the image forming apparatus 10 includes an acquisition unit 101, a reading unit 102, an image forming unit 103, a display control unit 104, a display unit 105, an image processing unit 300, a spot information storage unit 310, a cleaning requirement determination unit 311, and a reading device cleaning unit 312.

The acquisition unit 101 is a functional unit that acquires print data from the DFE 20 via the external I/F 504. The acquisition unit 101 acquires, for example, print data of a chart generated by the chart generation unit 201 and used for the uniformizing process from the DFE 20. For example, the CPU 501 illustrated in FIG. 4 executes a program so that the acquisition unit 101 is implemented.

The reading unit 102 is a functional unit that acquires read data by reading an image formed (or printed) on the sheet material P by the image forming unit 103. For example, the reading unit 102 performs a reading process with respect to the sheet material P as a printed matter on which the chart is printed by the image forming unit 103.

FIG. 8 is a diagram illustrating read data (i.e., read data as a chart) read by the reading unit 102 with respect to a printed matter of the chart on which an image is formed by the image forming unit 103. As illustrated in FIG. 7, in the chart that the print data before image formation indicates, the band-shaped area in the main scanning direction has the same density. However, as indicated by the read data (FIG. 8) acquired by reading the printed matter printed using the print data, the density in the main scanning direction varies in the band-shaped area. As illustrated in FIG. 3, in the liquid discharge unit 132 of the line-head type, since there are individual differences among the discharge heads 800 arranged in the main scanning direction, the individual differences appear as a variation in density of a printed matter. In order to cancel the variation in density, the uniformizing process described above is performed using the read data of the chart. However, when the reading device 40 has spot (e.g., spot of the light-receiving surface) at the time of performing uniformizing process, an abnormal value is mixed in the read value of the read data. Thus, the accuracy of correction is lowered by the uniformizing process. Accordingly, the image forming apparatus 10 according to the present embodiment performs a spot detection and uniformizing process, which will be described later.

The read data of the chart acquired by the reading unit 102 is transmitted to the image processing unit 300 via the external I/F 504. The reading unit 102 is implemented by the reading device 40 illustrated in FIGS. 1, 2, and 4.

The image forming unit 103 is a functional unit that performs image formation (i.e., printing) on the sheet material P based on the print data acquired by the acquisition unit 101. The image forming unit 103 is implemented by the image forming unit 130 illustrated in FIG. 2.

The display control unit 104 is a functional unit that performs display control of the display unit 105. For example, the CPU 501 illustrated in FIG. 4 executes a program so that the display control unit 104 is implemented.

The display unit 105 is a functional unit that performs a display operation under the control of the display control unit 104. The display unit 105 is implemented by the display unit 180 (as an example of a display device) illustrated in FIGS. 2 and 3.

As illustrated in FIG. 6, the image processing unit 300 includes a position specifying unit 301 (specifying unit), a standard deviation calculation unit 302 (calculation unit), an outlier determination unit 303 (first determining unit), a counting unit 304, a replacement unit 305, a uniformizing determination unit 306 (second determining unit), a uniformizing process unit 307, and a spot information output unit 308.

The position specifying unit 301 is a functional unit that specifies each area (i.e., divided area) as a unit in which the standard deviation is calculated by the standard deviation calculation unit 302, with respect to the read data of the chart acquired from the reading unit 102. More specifically, as illustrated in FIG. 8, the position specifying unit 301 specifies a paper white area WAR corresponding to a region in which ink is not printed, and further specifies a region in which ink is printed. The position specifying unit 301 divides each band-shaped area of the ink-printed region, which extends in the main scanning direction and corresponds to each density, into multiples areas with a predetermined width and specifies each of the divided areas as an area AR. For example, the position specifying unit 301 may specify, as the area AR, an area corresponding to each discharge head 800 of the liquid discharge unit 132 in a band-shaped area extending in the main scanning direction.

The standard deviation calculation unit 302 is a functional unit that calculates a total value of read values (densities) for each pixel column in the sub-scanning direction in each area (paper white area WAR and each area AR) of the read data specified by the position specifying unit 301, and calculates an average value (first average value) of each total value to calculate a standard deviation of these total values. The standard deviation calculation unit 302 is not limited to calculation of the standard deviation of the total values in each area, and may calculate, for example, the standard deviation of the read values in each area. In this case, the outlier determination unit 303 described later determines whether each read value of the area is an outlier by using the standard deviation. The total value and read value described above are examples of “values relating to read values” of the present disclosure. The standard deviation calculation unit 302 calculates an average value (second average value) of the read values of the respective areas. The average value may be referred to as an area average value in the following description. In this case, the standard deviation calculation unit 302 may calculate the area average value of the read values of each area after excluding the read values corresponding to the total value determined as an outlier by the outlier determination unit 303.

The outlier determination unit 303 is a functional unit that determines whether the total value of each area is an outlier using a standard deviation of each area (paper white area

WAR and each area AR) of the read data calculated by the standard deviation calculation unit 302. For example, the outlier determination unit 303 determines that the total value of the target area is an outlier when the total value of the target area is not within the range of (the average value) + (the standard deviation) of the target area. In the case where the total value of the target area is determined to be a clear outlier, for example, the outlier determination unit 303 may determine that the total value of the target area is an outlier when the total value of the target area is not within the range of (the average value) +2 x (the standard deviation) of the target area. In other words, the outlier determination unit 303 determines whether the total value is an outlier by comparison with respect to the standard deviation. The fact that the total value is an outlier in the target area indicates that an abnormal read value (i.e., abnormal value) caused by the spot of the reading device 40 exists in the pixel column corresponding to the total value in the target area.

The counting unit 304 is a functional unit that counts the number of times (i.e., count value) that the outlier determination unit 303 determines an outlier in each area. For example, the counting unit 304 may count the number of times the data is determined to be an outlier for each area, or may count the number of times the data is determined to be an outlier for all areas (i.e., the entire read data).

The replacement unit 305 is a functional unit that replaces the read value of the pixel column corresponding to the total value determined to be outlier by the outlier determination unit 303 with the area average. In other words, as described above, an abnormal value is included in the pixel column corresponding to the total value determined to be the outlier. For this reason, replacing all the read values of the pixel column by an area average value can prevent the influence of the abnormal value with respect to the uniformizing process. As described above, when the standard deviation calculation unit 302 calculates the area average value of the read values of each area after excluding the read values corresponding to the total value determined as an outlier by the outlier determination unit 303, the influence of the abnormal value on the uniformizing process can be further reduced.

The uniformizing determination unit 306 is a functional unit that determines whether the count value of the outlier counted by the counting unit 304 is equal to or smaller than a predetermined threshold and performs a spot detecting process. The threshold may be, for example, a parameter set by the setting unit 203 of the DFE 20 or a fixed value. When the uniformizing determination unit 306 determines that the count value of the outlier is equal to or smaller than the predetermined threshold, the degree of spot of the reading device 40 is determined to be allowable in performing the uniformizing process, and the uniformizing process is performed using the read data in which the outlier is replaced with the area average value by the replacement unit 305. On the other hand, when the uniformizing determination unit 306 determines that the count value of the outlier exceeds the predetermined threshold, it is determined that the degree of spot of the reading device 40 is not allowable in performing the uniformizing process, and the user can be prompted to clean the reading device 40 without performing the uniformizing process.

The uniformizing process unit 307 is a functional unit that performs the uniformizing process that uniformizes the density of a printed image in the main scanning direction by using the read data of the chart. In the present embodiment, the process performed by the uniformizing determination unit 306 and the process performed by the uniformizing process unit 307 are collectively referred to as “spot detection and uniformizing process.” The read data of the chart is obtained by replacing the read values of the pixel column corresponding to the total value with the area average value by the replacement unit 305 when the outlier determination unit 303 determines that there is an outlier with respect to the total value in any area. More specifically, the uniformizing process by the uniformizing process unit 307 calculates a correction value for uniformizing the density of the image printed out from the image forming apparatus 10 in the main scanning direction.

The uniformizing process unit 307 transmits the correction value calculated by the uniformizing process to the image forming unit 103. The image forming unit 103 of the image forming apparatus 10 forms an image on the sheet material P after correcting the print data acquired by the acquisition unit 101 with the correction value calculated by the uniformizing process by the uniformizing process unit 307. Thus, the image formation can be performed in a state in which the variation in density in the main scanning direction is eliminated as in the case of the printed matter of the chart illustrated in FIG. 8. FIG. 9A is a diagram illustrating a state in which, when print data of images of the same density extending in the main scanning direction is printed on the sheet material P before the uniformizing process is performed, the density of an actually printed image varies in each area corresponding to each discharge head 800 due to individual differences among the discharge heads 800 of the liquid discharge unit 132. On the other hand, FIG. 9B is a diagram illustrating a state in which the image formation is performed on the sheet material P after the uniformizing process is performed and the print data is corrected by the above-described correction value. FIG. 9B illustrates the state in which the variation in density caused by the individual differences among the discharge heads 800 is eliminated in the actually printed image.

In the case where the uniformizing determination unit 306 determines that the count value of the outliers exceeds the predetermined threshold, the display control unit 104 displays the determination result on the display unit 105 so as to prompt the user to clean the reading device 40. In this way, the user can grasp the timing of cleaning of the reading device 40. However, it is not preferable to leave such a spot for a long period of time even when the count value is equal to or smaller than a predetermined threshold and the degree of the spot is small. In the present embodiment, even in such a case, the user can be prompted to clean the reading device 40 by using a method described later.

The spot information output unit 308 is a functional unit that detects the number of spots, the size of spots, and the position of spots based on the read data (images read by the reading device 40) and outputs the information (spot information). In this way, the spot information is acquired regardless of the determination result of the uniformizing determination unit 306 so that the spot information can be output even when the degree of spot is small. Thus, the spot information detection process according to the present embodiment may be used for purposes other than the uniformizing process.

A learned model that has been subjected to machine learning may be used for detecting the spot information. For example, appropriate data from images detected as spot information in the past can be accumulated as learning data, and a learned model can be generated from the learning data. The spot information output unit 308 can detect the spot information from the read data by using such a learned model.

In the present disclosure, the machine learning is defined as a technology that makes a computer to acquire human-like learning ability. In addition, the machine learning refers to a technology in which a computer autonomously generates an algorithm required for determination such as data identification from learning data loaded in advance and applies the generated algorithm to new data to make a prediction. Any suitable learning method is applied for machine learning, for example, any one of supervised learning, unsupervised learning, semi-supervised learning, reinforcement learning, and deep learning, or a combination of two or more those learning methods.

The spot information storage unit 310 is a functional unit that stores the spot information received from the spot information output unit 308 in a storage device such as the HDD 520 together with information on the date and time when the spot is detected.

The cleaning requirement determination unit 311 compares the spot information received from the spot information output unit 308 (i.e., received spot information) with the previous spot information stored in the spot information storage unit 310 (i.e., stored spot information), and determines whether the cleaning of the reading device 40 is required. The cleaning requirement determination unit 311 determines that the cleaning of the reading device 40 is required when the number or size of spot and the position of spot in the received spot information has not changed from the number or size of spot and the position of spot in the stored spot information for a long period of time. In other words, the cleaning requirement determination unit 311 compares the received spot information with the stored spot information, determines whether there is a spot of which the spot information has not changed for a long period of time, and determines that the cleaning of the reading device 40 is required when there is such a spot.

The change in the spot information is calculated by a change in the number of spots or a change in the size of spot, or may be calculated by a change in the position of spot. The degree of change in the spot information is calculated using the change in the number of spots or the change in the size of spot and the change in the position of the corresponding spot, and it is determined that the degree of change has not changed when the calculated degree of change is smaller than a predetermined threshold. When the spot information is determined to have not changed and the difference between the date and time of the received spot information and the date and time of the stored spot information exceeds a predetermined threshold, the cleaning requirement determination unit 311 determines that the spot information has not changed for a long period of time and the cleaning of the reading device 40 is required. The predetermined threshold and the predetermined value may be determined in advance by experiments, may be determined by evaluation experiments when the image forming apparatus 10 is designed, or may be determined by tests performed by a model or a type of the image forming apparatus in the manufacturing process.

When the cleaning requirement determination unit 311 determines that the reading device 40 is required to be cleaned, the display control unit 104 displays a message indicating that the reading device 40 is required to clean on the display unit 105. Accordingly, the display control unit 104 can prompt the user to clean the reading device 40. In this case, the display control unit 104 may display, on the display unit 105, not only the message but also information such as the number of spots and the number of spot portions, the number of days in which the spot information has not changed. Accordingly, the user can recognize the requirement of cleaning of the reading device 40 and grasp the timing of cleaning.

The reading device cleaning unit 312 cleans the reading device 40 based on an instruction from the user.

The CPU 501 executes programs so that a part or all of the above-described functional units are implemented. Further, a part or all of the above-described functional units may be implemented by an integrated circuit such as an FPGA or an ASIC, instead of a program that is software.

The functional units of the image forming apparatus 10 illustrated in FIG. 6 conceptually indicate the functions, and the functional units are not limited to the configuration in FIG. 4. For example, multiple functional units illustrated as independent functional units in the image forming apparatus 10 illustrated in FIG. 6 may be configured as one functional unit. On the other hand, the functions included in one functional unit may be divided into multiple functional units.

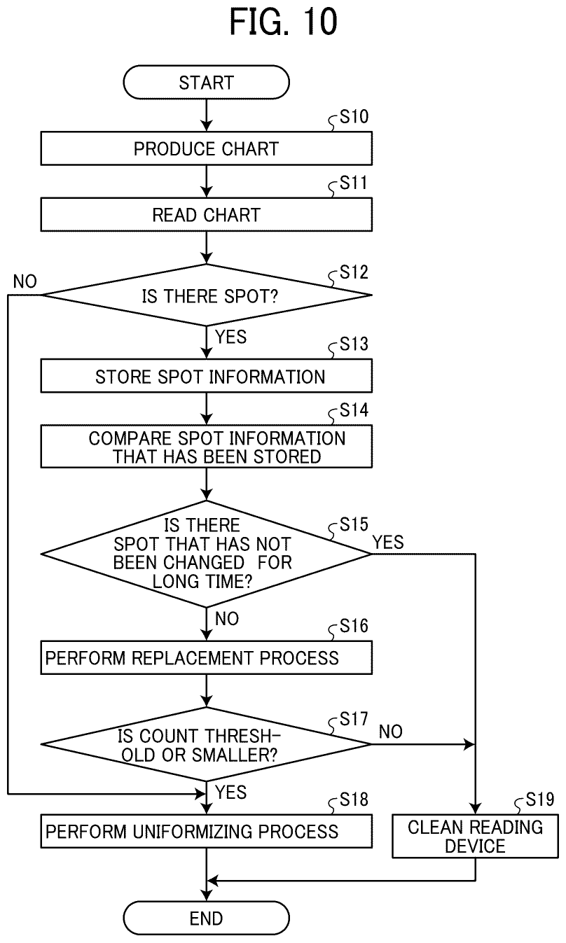

FIG. 10 is a flowchart of a process of determining whether the cleaning of the reading device 40 is required, according to an embodiment of the present disclosure. The chart generation unit 201 generates a chart in step S10, the generated chart is printed, and the reading unit 102 acquires read data of the chart in step S11.

The spot information output unit 308 detects the spot information based on the read data, and executes the uniformizing process in step S18 when there is no spot (NO in step S12), and the spot information storage unit 310 stores the spot information in step S13 when there is spot (YES in step S12). The cleaning requirement determination unit 311 compares the received spot information with the stored spot information in step S14, and in step S15 determines whether there is a spot of which the spot information has not changed for a long period of time.

When there is no spot of which the spot information has not changed for a long period of time (NO in step S15), the replacement unit 305 performs replacement process in step S16. The uniformizing determination unit 306 determines the degree of spot using the count value and a predetermined threshold (i.e., performs spot detecting process), and when the count value is equal to or smaller than the predetermined threshold (YES in step S17), the uniformizing process unit 307 performs the uniformizing process in step S18. On the other hand, when the count value is greater than the predetermined threshold (NO in step S17), in step S19, the display control unit 104 causes the display unit 105 to display a message that prompts the user to clean the reading device 40, and the reading device 40 is cleaned by the user.

When there is a spot of which the spot information has not changed for a long period of time (YES in step S15), in step S19, the display control unit 104 causes the display unit 105 to display a message that prompts the cleaning of the reading device 40, and the reading device cleaning unit 312 cleans the reading device 40 based on an instruction from the user. Accordingly, the method can prompt the user to clean the reading device 40 even when the degree of spot is small.

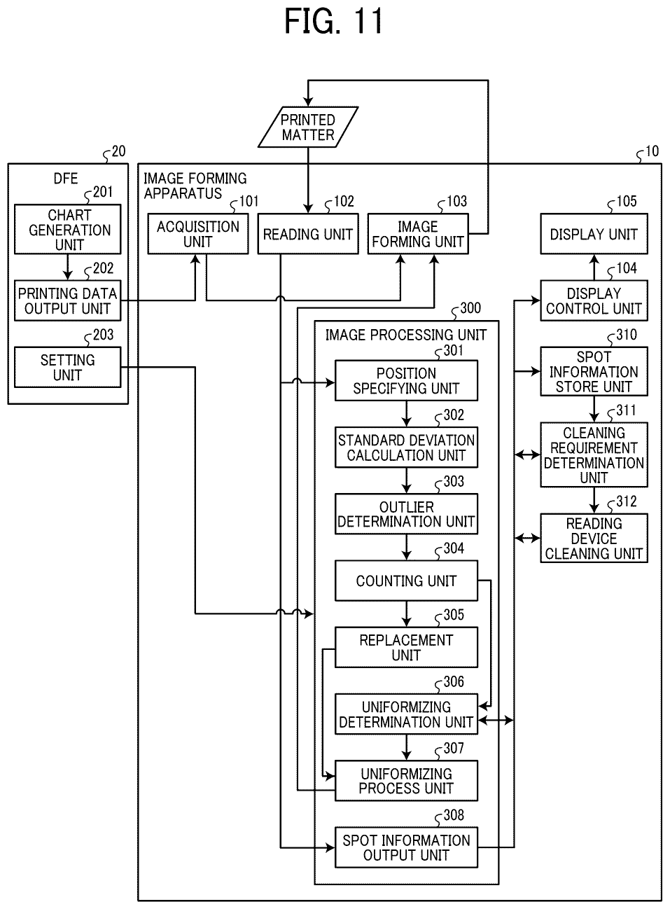

When the cleaning requirement determination unit 311 determines that the reading device 40 is required to be cleaned, the reading device cleaning unit 312 may receive the determination result and automatically execute the cleaning of the reading device 40. FIG. 11 is a diagram illustrating the configuration of the functional blocks of the image forming apparatus 10 and the DFE 20 according to a modification of the present embodiment. In the functional blocks illustrated in FIG. 11, a signal indicating that the cleaning of the reading device 40 is determined to be required is sent from the cleaning requirement determination unit 311 and the uniformizing determination unit 306 to the reading device cleaning unit 312, which is different from the functional blocks illustrated in FIG. 6. The reading device cleaning unit 312 is a functional unit that executes the cleaning of the reading device 40 when receiving the signal indicating that the cleaning of the reading device 40 is determined to be required from the cleaning requirement determination unit 311 or the uniformizing determination unit 306.

In this modification, the reading device cleaning unit 312 may automatically clean the reading device 40 as described above, and the display control unit 104 may display on the display unit 105 that cleaning is automatically being performed. In this way, the user can recognize that the cleaning of the reading device 40 is being executed. Further, in terms of the cleaning of the reading device 40, a mode manually executed by a user (i.e., manual cleaning mode) and a mode automatically executed (i.e., automatic cleaning mode) are set so that the user may select the modes. For example, in the case where the manual cleaning mode is selected, the cleaning requirement determination unit 311 or the uniformizing determination unit 306 determines that the cleaning of the reading device 40 is required, and the display control unit 104 displays a message indicating the requirement of cleaning of the reading device 40 on the display unit 105 to prompt the manual cleaning to the user. In the case where the automatic cleaning mode is selected, the cleaning requirement determination unit 311 or the uniformizing determination unit 306 determines that the cleaning of the reading device 40 is required, and the reading device cleaning unit 312 automatically executes the cleaning of the reading device 40. The mode describe above may be selected in advance by the user. Alternatively, in the case where the cleaning requirement determination unit 311 or the uniformizing determination unit 306 determines that the cleaning of the reading device 40 is required, the display control unit 104 displays a mode selection screen on the display unit 105 so that the user may select a mode using the mode selection screen.

Although the uniformizing determination unit 306 of the present embodiment determines the degree of spot of the reading device 40 using the standard deviation and the determination of the outlier, the degree of spot may be determined using other image processing. For example, the difference between the original data of the chart generated by the DFE 20 and the read data of the chart read by the reading unit 102 can be calculated, and the number and size of spots can be detected by binarization processing. In the case of where the number of spots is greater than a predetermined threshold, it is determined that the degree of the spots is large, and the cleaning of the reading device 40 may be prompted. In the case of where the number of spots is equal to or smaller than the predetermined threshold, it is determined that the degree of the spots is small, and the uniformizing process may be performed. In the case where the size of the spots is greater than a predetermined threshold, it is determined that the degree of the spots is large, and the cleaning of the reading device 40 may be prompted. In the case where the size of the spots is equal to or smaller than the predetermined threshold, it is determined that the degree of the spots is small, and the uniformizing process may be performed.

Although the detection of the spot information in the uniformizing process has been described above as an example, the spot information detecting process according to the present embodiment may be used for purposes other than the uniformizing process.

As described above, according to the present embodiment, the image forming apparatus 10 can determine whether the cleaning of the reading device is required based on the spot information detected by using the image read by the reading unit, and the spot information and the date and time information stored in the spot information storage unit. Thus, the detected abnormality factor can be appropriately determined, and the reading device can be prevented from being left without cleaning for a long period of time even when the degree of spot is small. As a result, the usability for the user is increased.

### Second Embodiment

In the present embodiment, it is determined whether the abnormality factor detected in the read data is due to contamination of the reading device or due to an abnormality of the nozzle of the discharge head 800, and the cleaning of an appropriate portion is executed according to the determination result. In the following description of the configuration of the first embodiment, the description of the same configurations as in the first embodiment will be omitted, and those different from the first embodiment will be described.

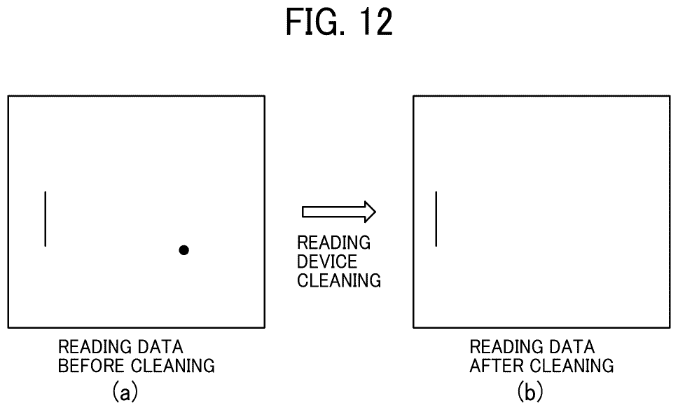

FIGS. 12A and 12B are diagrams illustrating reading data before and after cleaning of a reading device 40. FIG. 12A is a diagram illustrating an example of read data before cleaning, and in the read data, vertical linear spot and dot-shaped spot exist. FIG. 12B is a diagram illustrating an example of read data after cleaning, and in the read data, vertical linear spot exists. Since the dot-shaped spot is removed by cleaning the reading device 40, it is considered that the spot attached to the reading device 40 is the abnormality factor. On the other hand, since the vertical linear spot is not removed by cleaning, it may be spot due to an abnormality of the nozzle (i.e., nozzle abnormality) of the discharge head 800, which is referred to as “misfiring”. The nozzle abnormality includes a discharge failure due to contamination or clogging of the nozzle. In the present embodiment, when a spot that is not removed by the cleaning of the reading device is detected, the detected abnormality factor is determined as a nozzle abnormality.

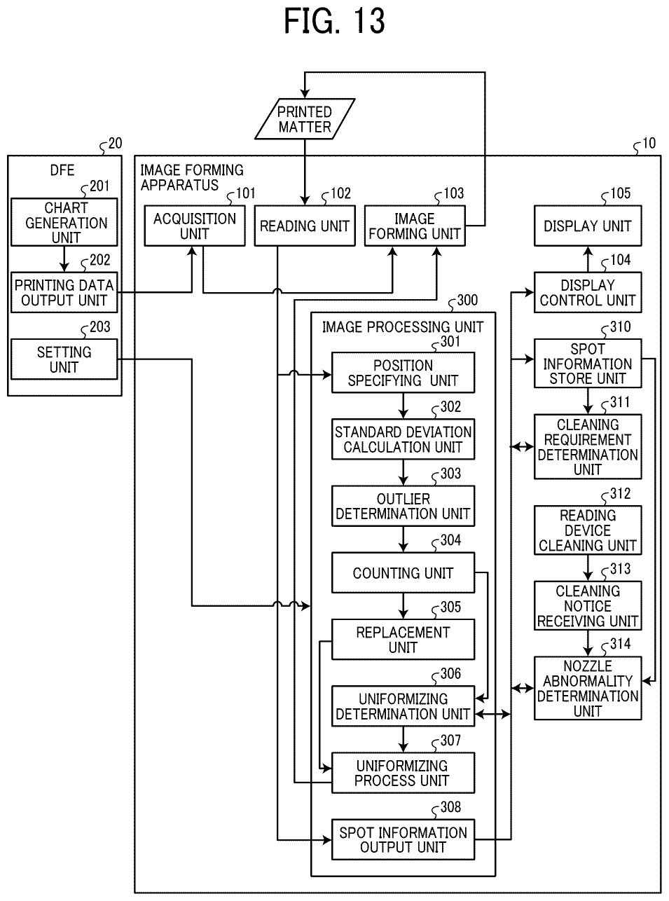

FIG. 13 is a diagram illustrating an example of the configuration of the functional blocks of the image forming apparatus 10 and the DFE 20 according to the present embodiment. The image forming apparatus 10 illustrated in FIG. 13 further includes a cleaning notice receiving unit 313 and a nozzle abnormality determination unit 314, which is different from the image forming apparatus 10 illustrated in FIG. 6.

The cleaning notice receiving unit 313 is a functional unit that receives a signal (i.e., cleaning notice) indicating that the reading device 40 has been cleaned from the reading device cleaning unit 312. The cleaning notice receiving unit 313 transmits the cleaning notice to the nozzle abnormality determination unit 314.

The nozzle abnormality determination unit 314 is a functional unit that determines whether the abnormality factor detected using the read data is a nozzle abnormality when receiving the cleaning notice from the cleaning notice receiving unit 313. The nozzle abnormality determination unit 314 determines whether there is a nozzle abnormality based on the spot information stored by the spot information storage unit 310 before the cleaning of the reading device 40 is performed (i.e., before-cleaning spot information) and the spot information detected by the image read by the reading device 40 after cleaning is performed (after-cleaning spot information).

For example, the nozzle abnormality determination unit 314 compares the position of the spot in the after-cleaning spot information with the position of the spot in the before-cleaning spot information. When the change in position is smaller than a predetermined threshold, it is determined that there is a spot that has not changed before and after cleaning. Accordingly, it is determined that there is a nozzle abnormality. Further, it may be determined that a nozzle abnormality exists when the number or size of spot of which the position change is smaller than a predetermined threshold is equal to or greater than a predetermined value. The predetermined threshold and the predetermined value may be determined in advance by experiments, may be determined by evaluation experiments when the image forming apparatus 10 is designed, or may be determined by tests performed by a model or a type of the image forming apparatus in the manufacturing process.

When it is determined that there is a nozzle abnormality, the display control unit 104 prompts the user to clean the nozzle by displaying a message indicating that the nozzle is required to be cleaned on the display unit 105. In this case, the display control unit 104 may display, on the display unit 105, not only the message but also information such as the number of spots and the number of spot portions, the number of days in which the spot information has not changed. Accordingly, the user can recognize the requirement of cleaning of the nozzle and grasp the timing of cleaning.

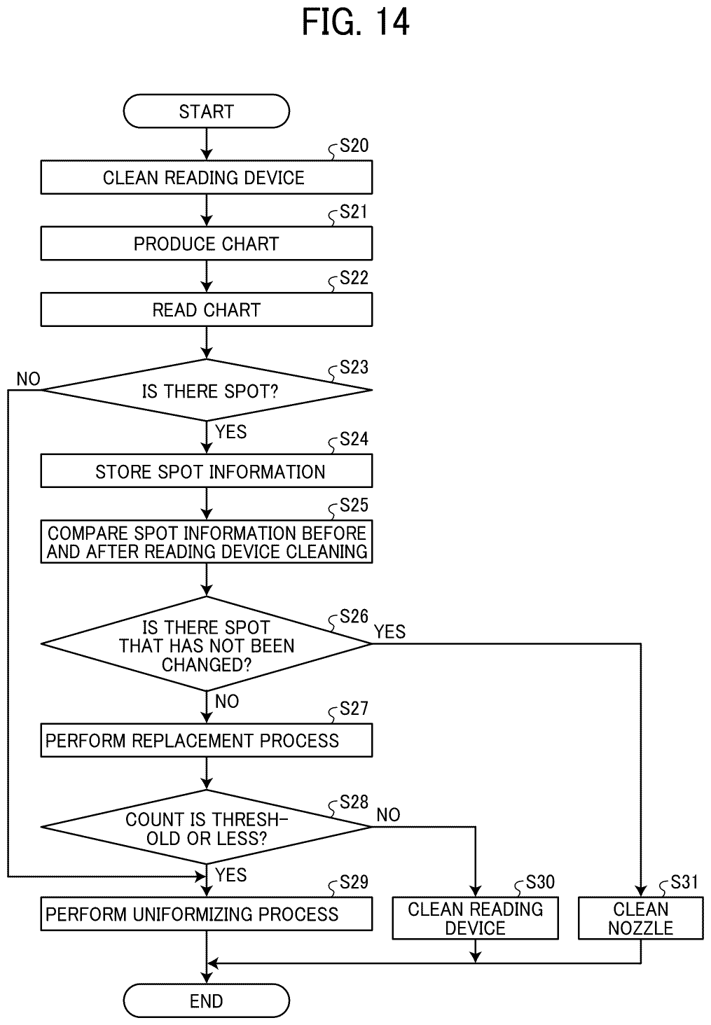

FIG. 14 is a flowchart of a process of determining whether the cleaning of a nozzle is required, according to an embodiment of the present disclosure. As described in the first embodiment, the cleaning of the reading device 40 is executed in step S20, and when the cleaning notice receiving unit 313 receives the cleaning notice, the process of detecting spot information using the chart is started again. The operations in the following steps S21 to S24 are the same as those in the steps S10 to S13 in FIG. 10.

The nozzle abnormality determination unit 314 compares the before-cleaning spot information and the after-cleaning spot information in step S25, and in step S26 determines whether there is a spot of which the spot information has not changed for a long period of time. If there is no unchanged spot (NO in step S26), the same processing as that described in the first embodiment is executed in steps S27 to S30. When the cleaning of the reading device 40 is executed in step S30, the process may return to step S21 to restart the spot detection process using the chart. In this case, an upper limit may be imposed on the number of times of cleaning of the reading device 40 continuously executed. When the number of times reaches the upper limit, the display control unit 104 may display a message that requests the repair to the administrator or the manufacturer of the device on the display unit 105. When the number of times reaches the upper limit, the cleaning of the reading device 40 may not be performed, and the process of the uniformizing process unit 307 may be executed to end the flow.

On the other hand, when there is a spot that has not changed (YES in step S26), in step S31, the display control unit 104 displays a message that prompts the cleaning of the nozzle on the display unit 105, and the user cleans the nozzle. Accordingly, the method can prompt the user to clean the nozzle when the abnormality factor detected in the read data may cause the nozzle abnormality.

When the nozzle abnormality determination unit 314 determines that the nozzle has abnormality, the determination result is received and the cleaning of the nozzle may be automatically executed. Alternatively, the cleaning of the nozzle is automatically executed, and the display control unit 104 may display a status in which the cleaning is automatically executed on the display unit 105. In this way, the user can recognize that the nozzle cleaning is being executed. Further, a mode in which the cleaning of the nozzle is manually executed by the user and a mode in which the cleaning of the nozzle is automatically executed may be provided, and the user may select the mode in advance. The mode describe above may be selected in advance by the user. Alternatively, in the case where the nozzle abnormality determination unit 314 determines that the nozzle has abnormality, the display control unit 104 displays a mode selection screen on the display unit 105 so that the user may select a mode using the mode selection screen.

As described above, according to the present embodiment, the image forming apparatus 10 can determine whether there is an abnormality in the nozzle based on the spot information stored in the spot information storage unit before cleaning of the reading device is performed and the spot information detected by the image read by the reading device after cleaning is performed. Thus, the abnormality factor detected from the read data is appropriately determined, and the user can grasp the timing at which the nozzle is to be cleaned. As a result, the usability of the user is increased.

In an embodiment described above, when at least one of the functional units of the image forming apparatus 10 and the DFE 20 is implemented by execution of a program, the program is installed in advance in, e.g., a ROM. The program executed by the image forming apparatus 10 and the DFE 20 according to an embodiment described above may be recorded in a computer-readable recording medium such as a compact disc read-only memory (CD-ROM), a flexible disk (FD), a compact disk-recordable (CD-R), or a digital versatile disk (DVD) in an installable format or an executable format, and provided. The program executed by the image forming apparatus 10 and the DFE 20 according to an embodiment described above may be stored in a computer connected to a network such as the Internet, and may be provided by downloading the programs via the network. The program executed by the image forming apparatus 10 and the DFE 20 according to an embodiment described above may be provided or distributed via a network such as the Internet. The program executed by the image forming apparatus 10 and the DFE 20 according to an embodiment described above has a module configuration including at least one of the functional units described above, and as an actual hardware, the CPU reads the program from the storage device described above and executes the program. As a result, the functional units described above are loaded onto the main storage device to be generated.

The functions of the embodiments described above can be implemented by one or multiple processing circuits. The “processing circuits” include a processor programmed to execute each function by software, such as a processor implemented by an electronic circuit, and devices such as an application specific integrated circuit (ASIC), a digital signal processor (DSP), a field programmable gate array (FPGA), and a conventional circuit module designed to execute each of the functions described above.

Aspects of the present disclosure are as follows.

### First Aspect

An image forming apparatus includes a reading unit to read an image using a reading device, a spot information storage unit to store spot information detected using the image read by the reading unit, a cleaning requirement determination unit, and a display control unit to control a display unit to display a message to a user. The spot information storage unit stores the spot information and date-and-time information on detection of the spot information. The cleaning requirement determination unit determines whether the reading device is required to be cleaned based on the spot information detected using the image read by the reading device, and the spot information and the date-and-time information stored in the spot information storage unit. The display control unit displays a message to prompt cleaning of the reading device when the cleaning requirement determination unit determines that the reading device is required to be cleaned.

### Second Aspect

The image forming apparatus according to the first aspect further includes a cleaning unit to clean the reading device and a nozzle abnormality determination unit to determine an abnormality of a nozzle. The nozzle abnormality determination unit determines the abnormality of the nozzle based on the spot information stored in the spot information storage unit before cleaning and the spot information detected using the image read by the reading device after cleaning.

### Third Aspect

In the image forming apparatus according to the first or second aspect, the display control unit displays a message to prompt cleaning of the nozzle when the nozzle abnormality determination unit determines that the nozzle has abnormality.

### Fourth Aspect

An image forming apparatus includes a reading unit to read an image using a reading device, a spot information storage unit to store spot information detected using the image read by the reading unit, a cleaning requirement determination unit, and a cleaning unit to clean the reading device. The spot information storage unit stores spot information and date-and-time information on detection of the spot information. The cleaning requirement determination unit determines whether the reading device is required to be cleaned based on the spot information detected using the image read by the reading device, and the spot information and the date-and-time information stored in the spot information storage unit. The cleaning unit cleans the reading device when the cleaning requirement determination unit determines that the reading device is required to be cleaned.

### Fifth Aspect

In the image forming apparatus according to any one of the first to fourth aspects, the spot information includes the number, the size, and the position of spot.

### Sixth Aspect

An image processing method is used in an image forming apparatus including a reading device to read an image and a display unit to display a message to a user. The image processing method includes reading an image using the reading device, storing spot information detected using the image read by the reading, determining cleaning requirement, and controlling the display unit. The storing stores the spot information and date-and-time information on detection of the spot information. The determining determines requirement of cleaning of the reading device based on the spot information detected using the image read in the reading, and the spot information and the date-and-time information stored in the storage unit. The controlling displays a message to prompt cleaning of the reading device when the determining determines that the reading device is required to be cleaned.

### Seventh Aspect

In an image forming apparatus including a reading device to read an image and a display unit to display a message to a user, a program causes a computer to read an image using the reading device, store spot information detected using the image read by the reading device, to determine requirement of cleaning of the reading device, and to control the display unit. The program causes the computer to store the spot information and date-and-time information on detection of the spot information, to determine whether the reading device is required to be cleaned based on the spot information detected using the image read by the reading device, and to control the display to display a message to prompt the user to clean the reading device when the determining determines that the reading device is required to be cleaned.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

1. An image forming apparatus, comprising:
a reading device to read an image;
circuitry configured to detect a first spot from the image read by the reading device;
a storage to store first spot information of the first spot detected from the image, and date-and-time information of time of detection of the first spot: and
a display to display a clean message to clean the reading device, wherein
the circuitry is further configured to:
detect second spot information from the image stored in the storage: and
compare the first spot information and the second spot information to determine whether the reading device is to be cleaned based on;
the first spot information,
the date-and-time information, and
the second spot information; and
the display displays the clean message when the circuitry determines that the reading device is to be cleaned.

2. The image forming apparatus according to claim 1, further comprising:
a discharge head including a nozzle to discharge a liquid from the nozzle; and
a cleaner to clean the reading device, wherein
the storage stores the first spot information before the cleaner cleans the reading device,
the reading device reads the image to acquire the first spot information after the cleaner cleans the reading device, and
the circuitry is further configured to:
compare the first spot information and the second spot information; and
determine whether the nozzle has abnormality based on a comparison between the first spot information and the second spot information.

3. The image forming apparatus according to claim 2, wherein the display displays the clean message to clean the nozzle the discharge head when the circuitry determines that the nozzle has an abnormality.

4. An image forming apparatus, comprising:
a reading device to read an image;
circuitry configured to detect a first spot from the image read by the reading device;
a storage to store
first spot information of the first spot detected from the image, and
first date-and-time information of time of detection of the first spot; and
a cleaner to clean the reading device, wherein
the circuitry is further configured to:
detect second spot information from the image stored in the storage;
compare the first spot information and the second spot information to determine whether the reading device is to be cleaned based on
the first spot information,
the date-and-time information, and
the second spot information; and
control the cleaner to clean the reading device.

5. The image forming apparatus according to claim 1, wherein the circuitry is further configured to acquire the first spot information and the second spot information each including a number and a size of a spot, and a position of the spot.

6. An information processing method, comprising:
reading an image by a reading device;
detecting a first spot from the image read by the reading device;
storing, in a storage, first spot information of the first spot and date-and-time information of time of detection of the first spot;
detecting second spot information from the image stored in the storage:
comparing the first spot information and the second spot information;
determining whether the reading device is to be cleaned based on;
the first spot information,
the date-and-time information, and
the second spot information; and
displaying a clean message when the reading device is determined to be cleaned.

7. A non-transitory recording medium storing multiple instructions which, when executed by one or more processors, causes the one or more processors to perform a method :
reading an image by a reading device; detecting a first spot from the image read by the reading device;
storing, in a storage, first spot information of the first spot and date-and-time information of time of detection of the first spot;
detecting second spot information from the image stored in the storage:
comparing the first spot information and the second spot information; determining whether the reading device is to be cleaned based on:
the first spot information,
the date-and-time information, and
the second spot information, and
displaying a clean message when the reading device is determined to be cleaned.
